(19) United States
(12) Patent Application Publication
(10) Pub. No.: US 2015/0290733 A1
(43) Pub. Date: Oct. 15, 2015

(54) WIRE ELECTRICAL DISCHARGE MACHINING APPARATUS, MACHINING CONTROL DEVICE, AND MACHINING CONTROL PROGRAM

(71) Applicant: Takayuki NAKAGAWA, (US)

(72) Inventor: Takayuki Nakagawa, Tokyo (JP)

(73) Assignee: Mitsubishi Electric Corporation, Tokyo (JP)

(21) Appl. No.: 14/439,349

(22) PCT Filed: Oct. 30, 2012
(86) PCT No.: PCT/JP2012/078065

§ 371 Date: Apr. 29, 2015

(51) Int. Cl. B23H 7/10; B23H 7/20; B23H 7/14

(52) U.S. Cl. CPC B23H 7/104; B23H 7/14; B23H 7/20

(57) ABSTRACT

The wire electrical discharge machining apparatus includes: a tension control motor controlling tension and feed speed of the wire extending under tension between a tension control roller and a winding roller by controlling the tension control motor; an external force estimator calculating an external force estimate applied to the tension control motor; an external force determiner determining, based on the external force estimate, whether there is a sign indicative of breaking of the wire; a machining power control device controlling a machining power source to reduce electrical discharge machining energy between the wire and a workpiece when determining that there is a sign indicative of breaking of the wire; a motor position detector detecting a rotational position of the tension control motor; and a motor control device controlling the tension control motor on the basis of the rotational position such that the feed speed stays within a predetermined range.

### FIELD

The present invention relates to a wire electrical discharge machining apparatus that machines a workpiece while winding a fed wire at a predetermined speed, a machining control device, and a machining control program.

### BACKGROUND

Conventional wire electrical discharge machining apparatuses detect the speed of a wire feeding control motor and the speed of a wire take-up motor. The wire electrical discharge machining apparatuses calculate the amount of elongation of the wire from the difference between the detected speeds, compare the amount of elongation to a reference value, and control the machining power source on the basis of the comparison result.

Such wire electrical discharge machining apparatuses perform wire electrical discharge machining on a workpiece while maintaining a constant tension in the wire. Thus, when the amount of elongation of the wire exceeds a predetermined value, the energy of the electrical discharge machining pulses per unit time is suppressed in order to prevent the wire from breaking (see Patent Literature 1, for example).

### CITATION LIST

### Patent Literature

Patent Literature 1: Japanese Patent Application Laid-Open No. S60-141430

### SUMMARY

### Technical Problem

The conventional technique described above requires time for the wire temperature to fall after the energy of electrical discharge machining pulses is suppressed; therefore, the wire continues to stretch until it is cooled down. However, the time from when the wire starts to stretch until when the wire actually breaks is short, making it difficult to prevent the wire from breaking. The conventional technique also needs high-speed calculation of the speed difference between the two motors; therefore, there is a problem in that two expensive detectors and high-speed transmission of detected signals are required.

The present invention has been achieved in view of the above and an object of the present invention is to provide a wire electrical discharge machining apparatus, a machining control device, and a machining control program that prevent the wire from breaking with a simple configuration.

### Solution to Problem

In order to solve the above problems and achieve the object, the present invention relates to a wire electrical discharge machining apparatus, including: a machining power source that applies a voltage between a wire and a workpiece; a wire feed roller that is arranged on a side from which the wire is fed and feeds the wire; a winding roller that is arranged on a side to which the wire is collected and winds the wire at a constant speed; a tension control motor that controls a tension and a feed speed of the wire extending under tension between the wire feed roller and the winding roller by controlling the wire feed roller; an external force estimator that calculates an estimated value of an external force applied to the tension control motor as an external force estimate; a determining unit that determines, on a basis of the external force estimate, whether there is a sign indicative of breaking of the wire; a power control device that, when it is determined that there is a sign indicative of breaking of the wire, controls the machining power source such that electrical discharge machining energy that the machining power source is to apply between the wire and the workpiece is reduced; a motor position detector that detects a rotational position of the tension control motor; and a motor control device that controls the tension control motor on a basis of the rotational position such that a feed speed of the wire stays within a predetermined range.

### Advantageous Effects of Invention

The present invention achieves an effect of preventing a wire from breaking with a simple configuration.

### BRIEF DESCRIPTION OF DRAWINGS

FIG. 1 is a diagram of the configuration of a wire electrical discharge machining apparatus according to an embodiment.

FIG. 2 is a diagram of the configuration of an external force estimator.

FIG. 3 is a diagram of the configuration of a motor control device.

FIG. 4 is a diagram for explaining a breaking suppression control process based on an external force estimate.

FIG. 5 is a diagram for explaining motor speed control of a tension control motor.

FIG. 6 is a diagram for explaining a breaking suppression control process based on a change in motor speed of the tension control motor.

FIG. 7 is a diagram for explaining a method for determining breaking of a wire on the basis of the transition of external force estimates.

FIG. 8 is a diagram of an example result of the determination of breaking of the wire.

FIG. 9 is a diagram of the hardware configuration of a computer including the motor control device.

### DESCRIPTION OF EMBODIMENTS

Exemplary embodiments of a wire electrical discharge machining apparatus, a machining control device, and a machining control program according to the present invention will be described in detail below with reference to the drawings. The present invention is not limited to the embodiments.

### Embodiment

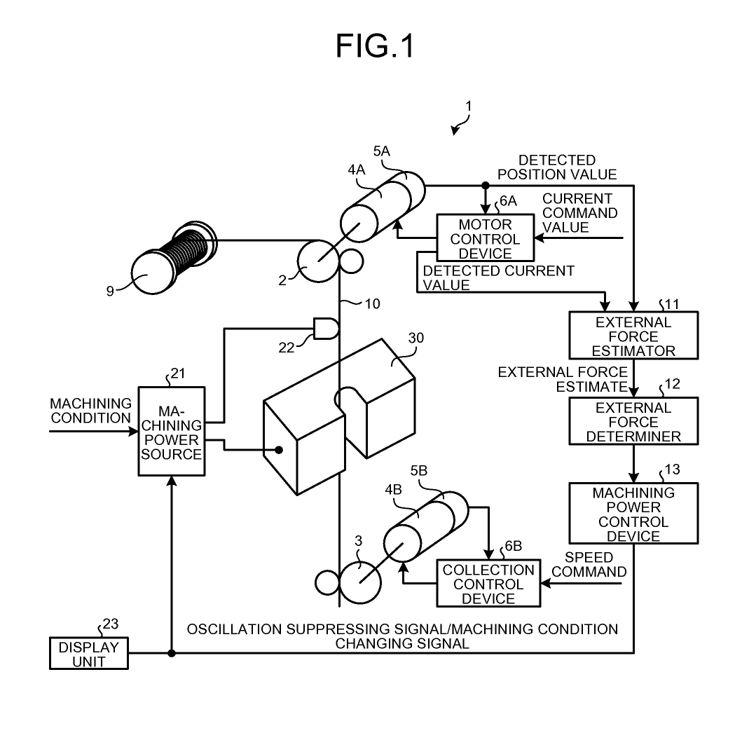

FIG. 1 is a diagram of the configuration of a wire electrical discharge machining apparatus according to an embodiment. A wire electrical discharge machining apparatus 1 is a device that winds a wire 10, which is paid out from a wire bobbin 9, at a predetermined collecting speed and machines a workpiece 30 with electrical discharge generated between the wire 10 and the workpiece 30.

The wire electrical discharge machining apparatus 1 detects changes in the tension in the wire 10, and, then, when a reduction in tension is detected in the feeding direction of the wire 10, the wire electrical discharge machining apparatus 1 suppresses electrical discharge machining pulse energy per unit time (hereinafter referred to as electrical discharge machining energy). The wire electrical discharge machining apparatus 1 according to the present embodiment suppresses fluctuations in motor speed (rotational speed) of a tension control motor 4A, which controls the tension in the wire 10, in order to reduce the tension when the wire 10 is stretched. In this manner, the wire electrical discharge machining apparatus 1 secures a sufficient period of time before the wire 10 breaks, during which period the wire electrical discharge machining apparatus 1 reduces the electrical discharge machining energy to prevent the wire 10 from breaking.

The wire electrical discharge machining apparatus 1 includes the wire bobbin 9, a tension control roller 2, and a winding roller 3. The wire bobbin 9 feeds the wire (a wire electrode) 10 to the tension control roller 2.

The tension control roller (wire feed roller) 2 is arranged on the side from which the wire 10 is fed. The tension control roller 2 controls the tension in the wire 10 by feeding the wire 10 from the wire bobbin 9 toward the workpiece 30. The tension control roller 2 is placed between the wire bobbin 9 and the workpiece 30 and applies tension mainly in a direction opposite to the traveling direction of the wire 10.

The winding roller 3 is arranged on the side to which the wire 10 is collected. The winding roller 3 winds the wire 10 fed from the wire bobbin 9 via the tension control roller 2 at a substantially constant collecting speed. With this configuration, the wire 10 extends under tension between the tension control roller 2 and the winding roller 3. The workpiece 30 is machined with the wire 10 extending under tension.

The wire electrical discharge machining apparatus 1 also includes the tension control motor 4A, a motor position detector 5A, a motor control device 6A, an external force estimator 11, an external force determiner (determining unit) 12, a machining power control device 13, a collecting motor 4B, a collection detector 5B, and a collection control device 6B.

The tension control motor 4A is a motor that controls the tension control roller 2. The tension control motor 4A is connected to the tension control roller 2 to control the tension applied by the tension control roller 2 to the wire 10 and the speed (feed speed) of the wire 10 in the feeding direction. The motor position detector 5A detects the rotational position of the tension control motor 4A and transmits the detected value (detected position value) to the motor control device 6A and the external force estimator 11.

The motor control device 6A is a device that controls the tension control motor 4A. The motor control device 6A receives, as input signals, a signal (the detected position value) transmitted from the motor position detector 5A and a current command value transmitted from a control device.

The motor control device 6A generates current (wire control current) on the basis of the detected position value and the current command value in order to control the torque generated by the tension control motor 4A and the rotational speed of the tension control motor 4A. The wire control current from the motor control device 6A is detected by a current detector 8, which will be described hereinafter, and is input to the external force estimator 11 as a detected current value.

The motor control device 6A according to the present embodiment controls the tension control motor 4A on the basis of the detected position value transmitted from the motor position detector 5A in such a manner that changes in the feed speed of the wire 10 stay within a predetermined range.

The external force estimator (an external force calculator) 11 is connected to the motor position detector 5A and the motor control device 6A. The external force estimator 11 stores in advance the relationships between the current to be supplied to the tension control motor 4A and the torque to be generated and the relationships between the torque and acceleration.

The external force estimator 11 uses the stored relationships, the current supplied by the motor control device 6A to the tension control motor 4A, and the signal (the detected position value) transmitted from the motor position detector 5A to estimate the tension in the wire 10 in the feeding direction. The tension in the wire 10 is an external force transferred from the wire 10 via the tension control roller 2 to the tension control motor 4A. Thus, the external force estimator 11 calculates the estimated value of an external force due to friction and the wire tension as an external force estimate. The external force estimator 11 transmits the external force estimate to the external force determiner 12.

The external force determiner 12 is connected to the external force estimator 11. The external force determiner 12 determines, on the basis of the external force estimate, whether there is a sign indicative of breaking of the wire 10. Specifically, the external force determiner 12 determines that the external force in the wire feeding direction has been reduced if the external force estimate transmitted from the external force estimator 11 has been reduced such that it is less than a predetermined determination value (threshold). When the external force estimate is less than the determination value, the external force determiner 12 transmits, to the machining power control device 13, the result of the determination (abnormality determination information) indicative of a reduction in external force. When the external force estimate is not less than the determination value, the external force determiner 12 transmits, to the machining power control device 13, the result of the determination (normality determination information) indicating that the external force is within a permissible range.

The machining power control device 13 is connected to the external force determiner 12. The machining power control device 13 controls a machining power source 21 on the basis of the result of the determination transmitted from the external force determiner 12. For example, when the result of the determination provides the abnormality determination information, the machining power control device 13 controls the machining power source 21 such that the electrical discharge machining energy is suppressed. In other words, if it is determined that there is a sign indicative of breaking of the wire 10, the machining power control device 13 transmits an instruction to the machining power source 21 to reduce the electrical discharge machining energy that the machining power source 21 is to apply between the wire 10 and the workpiece 30. In this manner, the electrical discharge machining energy is suppressed when the external force in the wire feeding direction is reduced.

Specifically, if the result of the determination provides the abnormality determination information, the machining power control device 13 transmits an oscillation suppressing signal or a machining condition changing signal to the machining power source 21. The oscillation suppressing signal is, for example, an instruction to lower the frequency of the electrical discharge machining pulses. As the oscillation suppressing signal, for example, an instruction to stop electrical discharge machining pulses and an instruction to lower the frequency of electrical discharge machining pulses to a predetermined value are transmitted to the machining power source 21.

The machining condition changing signal is an instruction to change the machining condition to be used by the machining power source 21. As the machining condition changing signal, for example, an instruction to reduce the electrical discharge machining pulse energy to zero and an instruction to reduce the pulse energy per electrical discharge machining pulse to a predetermined value are transmitted to the machining power source 21.

The machining power control device 13 is also connected to a display unit 23. The machining power control device 13 notifies the display unit 23 of the reduction of the electrical discharge machining energy, the machining position at which the electrical discharge machining energy is reduced, and the like.

The collecting motor (a wire winding motor) 4B is a motor that controls the winding roller 3. The collecting motor 4B is connected to the winding roller 3 and controls the speed at which the winding roller 3 winds the wire 10.

The collection detector (a wire winding unit) 5B detects the state of winding of the wire 10 by detecting the rotational angle of the collecting motor 4B. The collection detector 5B transmits the detected value (detection result of the rotational angle) to the collection control device 6B.

The collection control device (a wire winding control device) 6B receives, as input signals, the detection result of the rotational angle transmitted from the collection detector 5B and a speed command transmitted from the control device. The collection control device 6B causes the collecting motor 4B to rotate at a substantially constant speed on the basis of the detection result of the rotational angle and the speed command.

The wire electrical discharge machining apparatus 1 includes the machining power source 21, a power feed contact 22, and the display unit 23. The machining power source 21 is connected to the machining power control device 13. The machining power source 21 is a power supply device that applies a voltage between the wire 10 and the workpiece 30 on the basis of a preset machining condition. If the external force in the wire feeding direction is reduced, the machining power source 21 reduces the electrical discharge machining energy in response to a signal from the machining power source device 13.

The machining power source 21 is electrically connected to the power feed contact 22 and the workpiece 30. The power feed contact 22 is arranged so as to be in contact with the wire 10. The display unit 23 is a display device, such as a liquid crystal monitor, and presents information such as the reduction of electrical discharge machining energy and the machining position at which the electrical discharge machining energy is reduced.

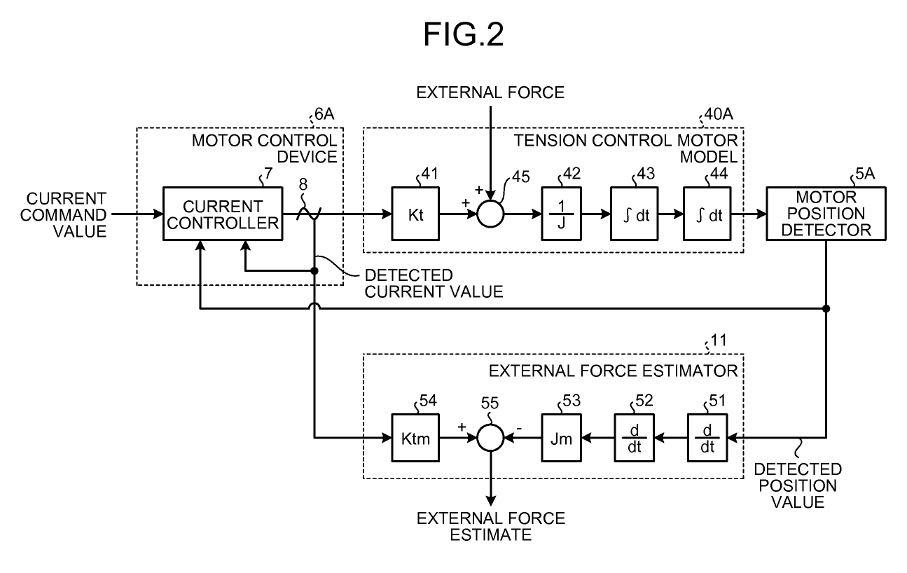

The configuration of the external force estimator 11 will now be described. FIG. 2 is a diagram of the configuration of the external force estimator. Here, the configuration of the motor control device 6A and, then, a tension control motor model 40A, which is a physical model of the tension control motor 4A, will be described before the description of the configuration of the external force estimator 11.

The motor control device 6A includes a current controller 7 (such as a servo amplifier) and the current detector 8. The current controller 7 receives, as input signals, the current command value transmitted from the control device, the detected position value transmitted from the motor position detector 5A, and the detected current value transmitted from the current detector 8. The current controller 7 uses the current command value, the detected position value, and the detected current value to generate the wire control current for providing the tension and speed to the wire 10. The current controller 7 transmits the generated wire control current through the current detector 8 to the tension control motor 4A. The current detector 8 detects a current value of the wire control current, which is transmitted from the current controller 7 to the tension control motor 4A, and transmits the detected current value to the current controller 7 and the external force estimator 11.

The tension control motor model 40A includes a converting unit 41 for converting a motor current to a torque, a converting unit 42 for converting the torque by moment of inertia to an acceleration, a converting unit 43 for converting the acceleration to a speed, a converting unit 44 from the speed to a position, and an adding unit 45. The converting unit 41 multiplies the wire control current, which is transmitted from the motor control device 6A, by a torque constant Kt of the tension control motor 4A. The converting unit 41 transmits the result of the multiplication to the adding unit 45.

The adding unit 45 adds the result of the multiplication, which is transmitted from the converting unit 41, to the external force applied to the tension control motor 4A and transmits the result to the converting unit 42. The converting unit 42 divides the result of the addition (external force), which is transmitted from the adding unit 45, by the moment of inertia J of the tension control motor 4A to obtain the acceleration of the tension control motor 4A. The converting unit 42 transmits the result of the division (acceleration) to the converting unit 43.

The converting unit 43 integrates (∫dt) the acceleration, which is transmitted from the converting unit 42, with respect to time to obtain the speed (motor speed) of the tension control motor 4A. The converting unit 43 transmits the obtained motor speed to the converting unit 44.

The converting unit 44 integrates (∫dt) the motor speed, which is transmitted from the converting unit 43, with respect to time to obtain the position of the tension control motor 4A. The converting unit 44 transmits the obtained position of the tension control motor 4A to the motor position detector 5A. The motor position detector 5A transmits the position of the tension control motor 4A as the detected position value to the motor control device 6A and the external force estimator 11.

The external force estimator 11 includes differentiation units 51 and 52, a moment-of-inertia multiplying unit 53, a torque-constant multiplying unit 54, and a subtracting unit 55. The differentiation unit 51 differentiates (d/dt) the detected position value, which is transmitted from the motor position detector 5A, with respect to time to obtain the motor speed of the tension control motor 4A. The differentiation unit 51 transmits the obtained motor speed to the differentiation unit 52.

The differentiation unit 52 further differentiates (d/dt) the motor speed, which is transmitted from the differentiation unit 51, with respect to time to obtain the acceleration of the tension control motor 4A. The differentiation unit 52 transmits the obtained acceleration to the moment-of-inertia multiplying unit 53.

The moment-of-inertia multiplying unit 53 multiplies the acceleration, which is transmitted from the differentiation unit 52, by the moment of inertia Jm (an estimated value). The moment-of-inertia multiplying unit 53 transmits the result of the multiplication (an external force calculated from the detected position value) to the subtracting unit 55.

The torque-constant multiplying unit 54 multiplies the detected current value, which is transmitted from the motor control device 6A (the current detector 8), by the torque constant Kt (an estimated value) of the tension control motor 4A. The torque-constant multiplying unit 54 transmits the result of the multiplication (an external force calculated from the detected current value) to the subtracting unit 55.

The subtracting unit 55 subtracts the result of the multiplication, which is transmitted from the moment-of-inertia multiplying unit 53, from the result of the multiplication, which is transmitted from the torque-constant multiplying unit 54. The subtracting unit 55 transmits the result of the subtraction (the result of estimation) to the external force determiner 12 as the external force estimate. As described above, the external force estimator 11 estimates an external force by performing calculations opposite to those performed by the tension control motor model 40A (inverse operations).

With the wire electrical discharge machining apparatus 1, not only the workpiece 30 but also the wire 10 are machined with electrical discharge machining pulses. Moreover, the temperature of the wire 10 increases due to electrical discharge machining pulses, which softens the wire 10. In such a case, the wire 10 may break if the wire 10 is thinned due to the electrical discharge machining and continues to be stretched.

Thus, in the present embodiment, the motor control device 6A controls the tension in the wire 10 and controls such that fluctuations in the motor speed of the tension control motor 4A is suppressed within a short period of time (for example, 1 msec to 10 msec). In other words, the motor control device 6A according to the present embodiment has a tension controlling function and a motor speed controlling function (a speed controller).

As described above, the motor control device 6A according to the present embodiment suppresses fluctuations in the motor speed in such a manner that the motor speed stays within a predetermined range for a short period of time and, thus, is capable of reducing the wire tension automatically without switching motor controls when the wire 10 starts to stretch.

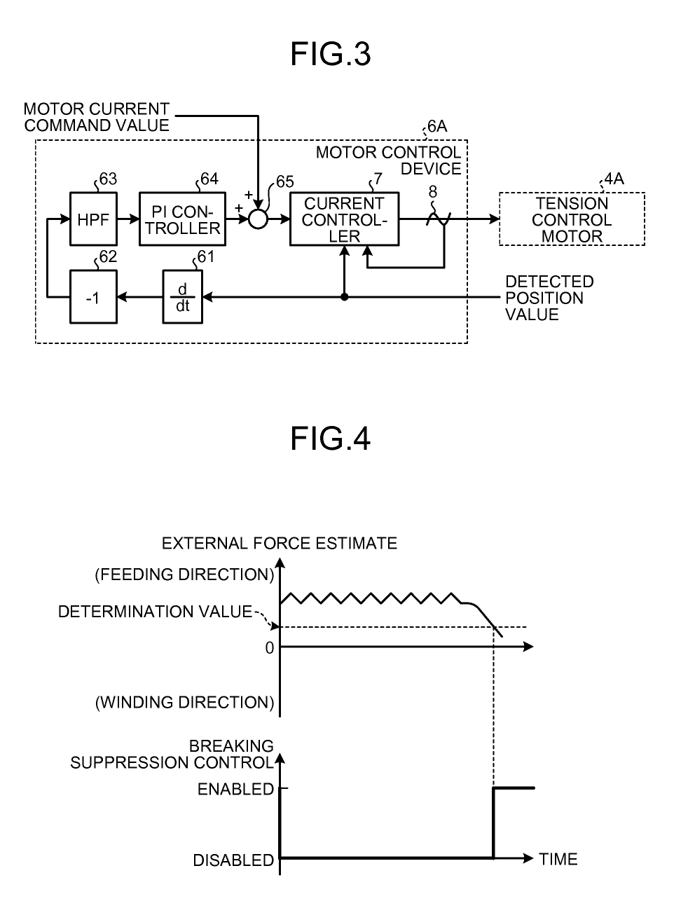

The configuration of the motor control device 6A will now be described. FIG. 3 is a diagram of the configuration of the motor control device. The motor control device 6A includes a differentiation unit 61, a reversing unit 62, an HPF (High-pass filter) 63, a PI controller 64, an adding unit 65, the current controller 7, and the current detector 8.

The differentiation unit 61 differentiates (d/dt) the detected position value, which is transmitted from the motor position detector 5A, with respect to time to obtain the motor speed of the tension control motor 4A. The differentiation unit 61 transmits the obtained motor speed to the reversing unit 62. The reversing unit 62 reverses the sign of the motor speed, which is transmitted from the differentiation unit 61, and transmits the result to the HPF 63.

The HPF 63 is a filter that allows the motor speed larger than a predetermined value to pass and blocks the motor speed smaller than the predetermined value. The HPF 63 allows a signal (the motor speed) larger than the predetermined value to pass among the signals received within a predetermined period of time (for example, within the past 10 msec). In other words, the HPF 63 blocks gradual signal fluctuations and allows an abrupt signal change to pass. In this manner, the HPF 63 obtains the amount of change of signals generated within the predetermined period of time and transmits the result to the PI controller 64.

The PI controller 64 performs PI control on the basis of the information (the amount of change of signals) transmitted from the HPF 63. When the motor speed is reduced, the PI controller 64 transmits a current value corresponding to the reduced motor speed to the adding unit 65. The adding unit 65 adds the current value, which is transmitted from the PI controller 64, to the current command value, which is transmitted from the control device. The adding unit 65 transmits the result of the addition to the current controller 7.

With this configuration, the current controller 7 receives the detected current value transmitted from the current detector 8, the detected position value transmitted from the motor position detector 5A, and the result of the addition (the current command value) transmitted from the adding unit 65. The current controller 7 then uses the detected current value, the detected position value, and the current command value to generate a wire control current and transmits the current to the tension control motor 4A.

As described above, the motor control device 6A controls such that the feed speed of the wire 10 (the motor speed of the tension control motor 4A) is substantially constant (within a predetermined range). Thus, even if the wire 10 starts to become thinner and stretched due to the electrical discharge machining, the feed speed of the wire 10 can be kept substantially constant, and, thus, the tension in the wire 10 can be reduced.

In this manner, the period of time before the wire 10 breaks can be extended. Thus, the wire 10 can be prevented from breaking during a period of time before the machining power source 21 suppresses energy to be applied to the wire 10, during a period of time from when the energy of the machining power source 21 is suppressed to when the wire temperature falls, and during a period of time before the stretched portion of the wire 10 is collected.

Note that, if the motor speed is input to the motor control device 6A, the differentiation unit 61 may be excluded from the motor control device 6A. In such a case, the motor speed corresponding to the detected position value is calculated in the motor position detector 5A or other devices external to the motor control device 6A and is then transmitted to the reversing unit 62.

Breaking suppression control (control to suppress breaking of the wire 10) process based on an external force estimate will now be described. FIG. 4 is a diagram for explaining a breaking suppression control process based on an external force estimate. During the wire electrical discharge machining, the winding roller 3 winds the wire 10 at a constant speed; therefore, an external force is applied to the wire 10 in the feeding direction. During the wire electrical discharge machining, the external force estimator 11 calculates the estimated value (the external force estimate) of the tension applied to the wire 10 in the feeding direction (the external force applied to the tension control motor 4A).

If the calculated external force estimate is equal to or more than a predetermined determination value, the probability of breaking of the wire 10 is low; therefore, the external force determiner 12 transmits, to the machining power control device 13, the result of the determination (normality determination information) indicating that the external force is within a permissible range. In such a case, the machining power control device 13 transmits no oscillation suppressing signal or machining condition changing signal to the machining power source 21. In other words, the machining power control device 13 disables the breaking suppression control (the control to suppress breaking of the wire 10). This causes the machining power source 21 to apply a normal voltage according to the machining condition between the wire 10 and the workpiece 30.

Moreover, when the calculated external force estimate is equal to or more than the predetermined determination value, the motor position detector 5A detects a normal detected position value as the position of the tension control motor 4A and transmits the detected value to the motor control device 6A. When the motor control device 6A receives the normal detected position value, the motor control device 6A transmits a normal wire control current value to the tension control motor 4A. In this manner, the motor control device 6A transmits, to the tension control motor 4A, a normal wire control current according to the current command value and the detected current value.

When a change in the external force applied to the tension control motor 4A is detected and a reduction in the external force in the wire feeding direction is detected, the wire electrical discharge machining apparatus 1 suppresses the electrical discharge machining energy. Specifically, if the calculated external force estimate is less than the predetermined determination value, the probability of breaking of the wire 10 is high; therefore, the external force determiner 12 transmits, to the machining power control device 13, the result of the determination (abnormality determination information) indicating that the external force is outside the permissible range. In such a case, the machining power control device 13 transmits the oscillation suppressing signal or the machining condition changing signal to the machining power source 21. In other words, the machining power control device 13 enables the breaking suppression control. This causes the machining power source 21 to apply a voltage according to the oscillation suppressing signal or the machining condition changing signal between the wire 10 and the workpiece 30.

When recovery of the external force in the wire feeding direction to the state present before the reduction of the external force is detected, the wire electrical discharge machining apparatus 1 restores the electrical discharge machining energy to the state present before the reduction of the external force. Note that the wire electrical discharge machining apparatus 1 may restore the electrical discharge machining energy to the state present before the reduction of the external force after confirmation that a collecting unit (not illustrated) positioned lower than the winding roller 3 has collected a stretched portion of the wire 10. Additionally, the wire electrical discharge machining apparatus 1 may control the electrical discharge machining energy such that the energy reaches the amount according to the external force estimate.

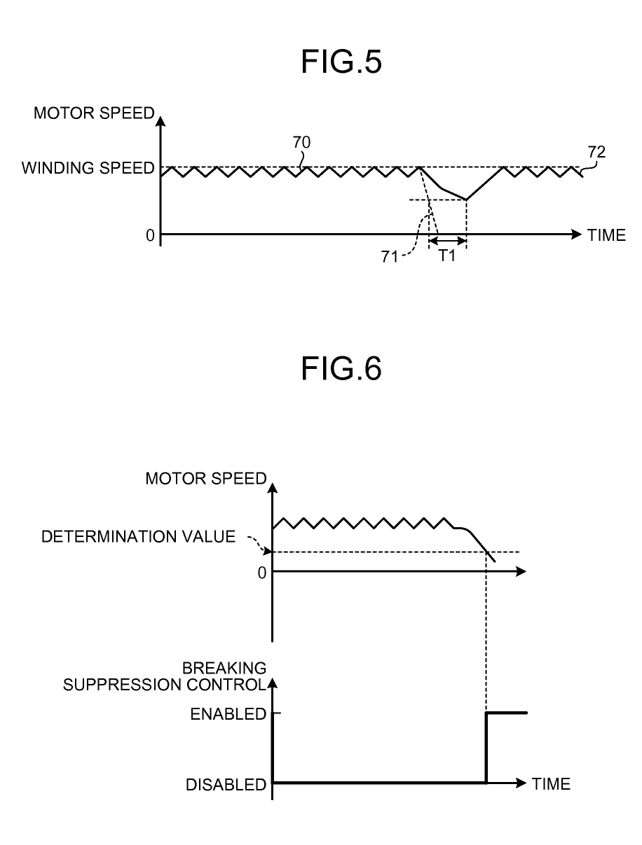

FIG. 5 is a diagram for explaining motor speed control of the tension control motor. With reference to FIG. 5, the horizontal axis represents time and the vertical axis represents the speed of the tension control motor (motor speed). Here, the motor speed corresponds to the speed of the wire 10 in the feeding direction. The dotted line in FIG. 5 represents the winding speed of the wire 10. While the wire electrical discharge machining apparatus 1 performs the wire electrical discharge machining, the wire 10 is wound by the winding roller 3 at a constant winding speed.

This causes tension in the wire 10 to be transferred to the tension control roller 2 and the tension control motor 4A. Thus, in this condition, the external force estimator 11 estimates by calculation that a large external force is present in the feeding direction. A motor speed 70 in this condition is represented by a substantially constant value.

For example, as the wire 10 starts to stretch with an increase in the temperature of the wire 10, the tension in the wire 10 is reduced temporarily. This causes the external force estimate to become a smaller estimated value in the feeding direction. Moreover, in some cases, the external force (an estimated value) becomes a force in the winding direction under the influence of friction of the wire bobbin 9 and the like.

As the external force estimate in the feeding direction is reduced, the motor speed 70 is also reduced. When the external force estimate drops below the predetermined determination value, the breaking suppression control is performed. It takes stopping time T1 from when it is detected that the external force is less than the predetermined determination value to when the breaking suppression control is actually started (the machining power source 21 is stopped).

In such a case, the motor speed continues to be reduced if the motor speed control is not performed. With reference to FIG. 5, a speed characteristic 71 represents a speed characteristic without the motor speed control. The tension in the wire 10 increases with the reduction in motor speed, making the wire 10 more likely to break.

In the present embodiment, the wire 10 is controlled such that the reduction in motor speed is suppressed, and, when the external force estimate drops below the predetermined determination value, the breaking suppression control is performed. With reference to FIG. 5, a speed characteristic 72 represents a speed characteristic with the motor speed control. As described above, by controlling the wire 10 such that the reduction in motor speed is suppressed, the breaking suppression control can be started before the tension in the wire 10 becomes equal to or more than a predetermined value (before the wire 10 breaks). Additionally, because the time taken for the tension in the wire 10 to become equal to or more than the predetermined value is prolonged, the wire portion that has caused the wire tension to increase can be wound before the wire 10 breaks. Due to the winding by the winding roller 3 of the wire portion that has caused the wire tension to increase, the motor speed returns to the normal value.

Note that the breaking suppression control may be performed after the motor speed returns to the normal value. In such a case, the motor speed does not drop below a predetermined value because the motor speed control is performed. Thus, the tension in the wire 10 does not become equal to or more than the predetermined value.

As described above, in the present embodiment, the breaking suppression control can be performed while an increase in the tension in the wire 10 is suppressed by performing the motor speed control therefore; the wire 10 can be prevented from breaking.

Additionally, the wire electrical discharge machining apparatus 1 estimates an external force by using the detected position value detected by the motor position detector 5A; therefore, there is no need to receive signals from a distant location. Hence, by incorporating the external force estimator 11 into the motor control device 6A, high-speed processing and cost reduction can be achieved.

While a change in the tension in the wire 10 is detected on the basis of an external force estimate in the present embodiment, a change in the external force applied to the wire 10 may be detected on the basis of a change in the motor speed of the tension control motor 4A. In such a case, the motor speed of the tension control motor 4A is calculated on the basis of, for example, the detected position value that is detected by the motor position detector 5A.

FIG. 6 is a diagram for explaining a breaking suppression control process based on a change in the motor speed of the tension control motor. In the breaking suppression control process based on a change in the motor speed of the tension control motor 4A, when the motor speed of the tension control motor 4A drops below a predetermined determination value, the external force determiner 12 transmits, to the machining power control device 13, the result of the determination (abnormality determination information) indicating that the external force is outside a permissible range.

With an abrupt reduction of the external force applied to the wire 10 in the feeding direction, the torque control based on the speed control on the wire 10 temporarily fails to provide a sufficient control amount. This would lead to an abrupt reduction in the speed of the wire 10 or changing of the speed of the wire 10 to the winding direction. Hence, by detecting a change in the tension in the wire 10 on the basis of a change in the motor speed of the tension control motor 4A, the calculation of the external force applied to the tension control motor 4A and the adjustment of parameters of the motor speed control are facilitated.

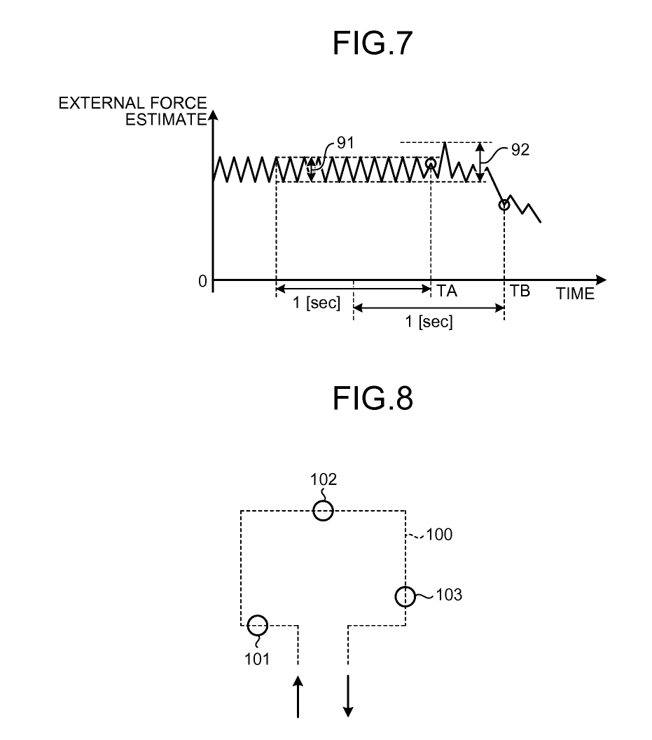

The external force determiner 12 may determine whether the wire 10 is likely to break on the basis of the transition (history) of external force estimates. FIG. 7 is a diagram for explaining a method for determining breaking of the wire on the basis of the transition of external force estimates.

The external force determiner 12 stores, for example, external force estimates obtained within the most recent predetermined time (for example, in the past 1 sec). The external force determiner 12 determines whether the present external force estimate provides a sign indicative of breaking of the wire 10 on the basis of the external force estimates obtained in the most recent predetermined time. At this point, the external force determiner 12, for example, statistically assesses the transition of the external force estimates to determine whether the present external force estimate causes the wire 10 to break.

For example, the external force determiner 12 calculates statistical data of external force estimates in the past 1 sec. Here, the statistical data includes a maximum value, a minimum value, a range, standard deviation, a variance, a mean value, a median, and a distribution. The external force determiner 12 determines whether there is a sign indicative of breaking of the wire 10 on the basis of the calculated statistical data and the present external force estimate.

For example, the external force determiner 12 extracts a minimum value from the external force estimates obtained in the past 1 sec and determines that the wire 10 is likely to break if the present external force estimate is less than X % of the minimum value (where X is 100 or less).

For example, if the transition of external force estimates is as illustrated in FIG. 7, the external force estimate at time TA is within a fluctuation range 91 in the past 1 sec. Thus, the external force determiner 12 determines that there is no sign indicative of breaking of the wire 10. In contrast, the external force estimate at time TB is below a fluctuation range 92 in the past 1 sec. Thus, the external force determiner 12 determines that there is a sign indicative of breaking of the wire 10.

As described above, it is determined whether the present external force (estimated value) causes breaking of the wire 10 by assessing the transition of external force estimates statistically; therefore, there is no need to adjust parameters of the determination of breaking in accordance with the diameter of the wire 10 and the tension in the wire 10. This facilitates the determination of breaking of the wire 10. Note that the external force determiner 12 may determine that there is a sign indicative of breaking of the wire 10 if the estimated value of the external force is a value in the winding direction.

The wire electrical discharge machining apparatus 1 may store the results of the determination of breaking of the wire 10. Additionally, the wire electrical discharge machining apparatus 1 may display the result of the determination of breaking of the wire 10 on the display unit 23 and output the result of the determination of breaking of the wire 10 to an external device or the like.

FIG. 8 is a diagram of an example result of the determination of breaking of the wire. With reference to FIG. 8, a machining path 100 is of the wire 10. During the wire electrical discharge machining along the machining path 100, a machining position is generated in some cases at which it is determined that there is a sign indicative of breaking of the wire 10. In such a case, the wire electrical discharge machining apparatus 1 stores the breaking indicating position on the machining path 100 as a result of the determination of breaking the wire 10. FIG. 8 illustrates a case where there are breaking indicating positions 101, 102, and 103. The wire electrical discharge machining apparatus 1 may display the machining path 100 and the breaking indicating positions 101, 102, and 103 on the display unit 23 during and after the machining of the workpiece 30.

This facilitates feedback to the machining conditions (such as energy adjustment in the machining power source 21). Moreover, the display unit 23 may be configured to include an indicator lamp or the like and turn on the indicator lamp when it is determined that there is a sign indicative of breaking (when the electrical discharge machining energy is reduced).

Note that the motor control device 6A may be configured to include at least one of the external force estimator 11, the external force determiner 12, and the machining power control device 13. The processes to be performed by the motor control device 6A, the external force estimator 11, the external force determiner 12, and the machining power control device may be performed with hardware or software.

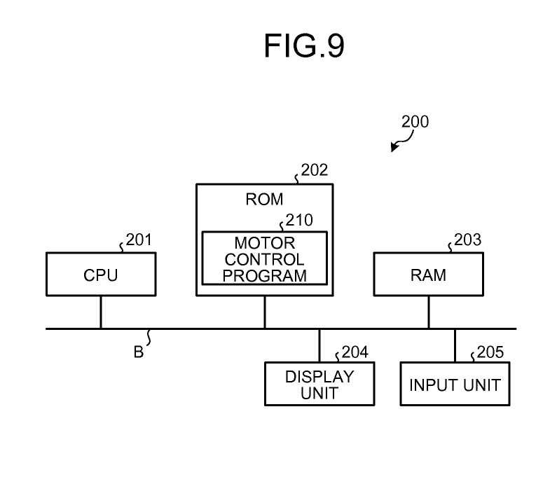

FIG. 9 is a diagram of the hardware configuration of a computer including the motor control device 6A. A computer 200 includes a CPU (Central Processing Unit) 201, a ROM (Read Only Memory) 202, a RAM (Random Access Memory) 203, a display unit 204, and an input unit 205. The CPU 201, the ROM 202, the RAM 203, the display unit 204, and the input unit 205 in the computer 200 are connected by a bus line B.

The CPU 201 controls the tension control motor 4A by using a motor control program 210, which is a computer program. The display unit 204 is a display device, such as a liquid crystal monitor, and presents a detected position value and the like according to an instruction from the CPU 201. The input unit 205 is configured to include a mouse and a keyboard and receives, as input signals, instruction information (parameters needed to control the tension control motor 4A, for example) input externally by the user. The instruction information input to the input unit 205 is transmitted to the CPU 201.

The motor control program 210 is stored in the ROM 202 and loaded through the bus line B into the RAM 203. The CPU 201 executes the motor control program 210 loaded in the RAM 203. Specifically, in the computer 200, the CPU 201 reads the motor control program 210 from the ROM 202 and loads the program in a program storage area in the RAM 203 to execute various processes according to the instructions input by the user through the input unit 205. The CPU 201 causes various types of data, which is generated during the various processes, to be stored temporarily in a data storage area formed in the RAM 203.

The motor control program 210 to be executed in the computer 200 is configured in modules including the motor control device 6A, and these modules are loaded into the main memory and generated in the main memory. Note that the processes to be performed by the external force estimator 11, the external force determiner 12, and the machining power control device may be executed by using the motor control program 210.

As described above, according to the present embodiment, even when the wire 10 is stretched, the tension in the wire 10 can be reduced without switching tension controlling schemes by suppressing the reduction in the motor speed of the tension control motor 4A. In this manner, the period of time before a tension significant enough to break the wire 10 is applied to the wire 10 can be extended. Thus, the energy of electrical discharge machining pulses can be reduced before the tension significant enough to break the wire 10 is applied to the wire 10. This allows a stretched portion of the wire 10 to be cooled. Then, by feeding the wire 10 beyond the workpiece 30 toward the winding roller 3, electrical discharge by the stretched portion of the wire 10 can be completed. It is therefore possible to prevent the wire 10 from breaking with a simple configuration.

### INDUSTRIAL APPLICABILITY

As described above, the wire electrical discharge machining apparatus, the machining control device, and the machining control program according to the present invention are suitable for electrical discharge machining of a workpiece using a wire electrode.

### REFERENCE SIGNS LIST

1 wire electrical discharge machining apparatus, tension control roller, 3 winding roller, 4A tension control motor, 4B collecting motor, 5A motor position detector, 6A motor control device, 7 current controller, 8 current detector, 10 wire, 11 external force estimator, external force determiner, 13 machining power control device, 21 machining power source, 30 workpiece, 61 differentiation unit, 62 reversing unit, 63 HPF, 64 PI controller, 65 adding unit.

1. A wire electrical discharge machining apparatus, comprising:
a machining power source that applies a voltage between a wire and a workpiece;
a wire feed roller that is arranged on a side from which the wire is fed and feeds the wire;
a winding roller that is arranged on a side to which the wire is collected and winds the wire at a constant speed;
a tension control motor that controls a tension and a feed speed of the wire extending under tension between the wire feed roller and the winding roller by controlling the wire feed roller;
an external force estimator that calculates an estimated value of an external force applied to the tension control motor as an external force estimate;
a determining unit that determines, on a basis of the external force estimate, whether there is a sign indicative of breaking of the wire;
a power control device that, when it is determined that there is a sign indicative of breaking of the wire, controls the machining power source such that electrical discharge machining energy that the machining power source is to apply between the wire and the workpiece is reduced;
a motor position detector that detects a rotational position of the tension control motor; and
a motor control device that controls the tension control motor on a basis of the rotational position such that a feed speed of the wire stays within a predetermined range, wherein
the rotational position of the tension control motor detected by the motor position detector and a current detection signal detected with respect to current supplied to the tension control motor by the motor control device are input to the external force estimator as information on an operation of the wire feed roller, and
the external force estimator calculates the external force estimate by using the rotational position and the current detection signal that have been input.

2. The wire electrical discharge machining apparatus according to claim 1, wherein the determining unit determines, on a basis of a transition of the external force estimate, whether there is a sign indicative of breaking of the wire.

3. (canceled)

4. The wire electrical discharge machining apparatus according to claim 1, further comprising a display unit that displays information indicating that there is a sign indicative of breaking of the wire when it is determined that there is a sign indicative of breaking of the wire.

5. A machining control device, comprising:
a control unit that controls a tension and a feed speed of a wire extending under tension between a wire feed roller and a winding roller by controlling the wire feed roller, the wire feed roller being arranged on a side from which the wire is fed and feeding the wire and the winding roller being arranged on a side to which the wire is collected and winding the wire at a constant speed;
an external force estimator that calculates an estimated value of an external force applied to the tension control motor as an external force estimate in accordance with a magnitude of the tension;
a determining unit that determines, on a basis of the external force estimate, whether there is a sign indicative of breaking of the wire; and
a power control device that, when it is determined that there is a sign indicative of breaking of the wire, controls a machining power source such that electrical discharge machining energy to be applied between the wire and the workpiece is reduced, wherein
the control unit controls a tension and a feed speed of the wire by controlling the tension control motor on a basis of a rotational position of the tension control motor that provides a tension and a feed speed to the wire such that a change in a feed speed of the wire stays within a predetermined range,
the rotational position and a current detection signal detected with respect to current supplied to the tension control motor by the control unit are input to the external force estimator as information on an operation of the wire feed roller, and
the external force estimator calculates the external force estimate by using the rotational position and the current detection signal that have been input.

6. A machining control program that causes a computer to execute;
a wire controlling step of controlling a tension and a feed speed of a wire by controlling a tension control motor on a basis of a rotational position of the tension control motor that provides a tension and a feed speed to the wire such that a feed speed of the wire stays within a predetermined range, the wire extending under tension between a wire feed roller and a winding roller, the wire feed roller being arranged on a side from which the wire is fed and feeding the wire, and the winding roller being arranged on a side to which the wire is collected and winding the wire at a constant speed;
an external force calculating step of, when the rotational position and a current detection signal detected with respect to current supplied to the tension control motor are input as information on an operation of the wire feed roller, calculating an estimated value of an external force applied to the tension control motor as an external force estimate by using the rotational position and the current detection signal that have been input;
a determining step of determining whether there is a sign indicative of breaking of the wire on a basis of the external force estimate; and
a power controlling step of, when it is determined that there is a sign indicative of breaking of the wire, controlling a machining power source such that electrical discharge machining energy to be applied between the wire and the workpiece is reduced.
